(19) United States
(12) Patent Application Publication
(10) Pub. No.: US 2006/0174271 A1
(43) Pub. Date: Aug. 3, 2006

(54) Methods and apparatus for providing program guide state information to a device

(76) Inventors: An Mei Chen, San Diego, CA (US); Binita Gupta, La Jolla, CA (US); Ravinder Paul (Rob) Chandhok, Poway, CA (US)

Correspondence Address: QUALCOMM, INC, 5775 MOREHOUSE DR., SAN DIEGO, CA, 92121, US

(21) Appl. No.: 11/184,603

(22) Filed: Jul. 18, 2005

Related U.S. Application Data
(60) Provisional application No. 60/589,822, filed on Jul. 20, 2004.

(51) Int. Cl. H04N 5/445; G06F 13/00; G06F 3/00

(52) U.S. Cl. 725/39; 725/50; 725/49

(57) ABSTRACT

Methods and apparatus for providing guide state information to a device. A method is provided for updating a program guide that comprises one or more sections. The method includes determining that a selected section of the program guide has changed, and generating a program guide state notification message that identifies the selected section of the program guide. The method also includes transmitting the program guide state notification message, and transmitting the selected section of the program guide.

### CLAIM OF PRIORITY UNDER 35 U.S.C. §119

The present Application for Patent claims priority to Provisional Application Ser. No. 60/589,822 entitled “METHOD AND APPARATUS FOR NOTIFYING MEDIAFLO PROGRAM GUIDE STATE INFORMATION” filed Jul. 20, 2004, and assigned to the assignee hereof and hereby expressly incorporated by reference herein.

### BACKGROUND

1. Field

The disclosed embodiments of the invention relate generally to the operation of content distribution systems, and more particularly, to methods and apparatus for providing program guide state information to devices in a data network.

2. Background

In current content delivery/media distribution systems, a program guide (PG), which may be provided to devices in a distribution network, describes a delivery schedule of available content or services. For example, a content distribution server that operates on the distribution network operates to provide the PG to devices in communication with the network. Devices receiving the PG operate to display information in the PG to a device user who then may select content or services to be received by the device. For example, a device user may select and subscribe to receive content or services that include multimedia content, clips, programs, scripts, data, customer services, or any other type of content or service.

Typically, the PG is transmitted to devices on the distribution network at periodic or fixed time intervals. In one implementation, a rolling transmission mechanism is used to transmit the entire PG over the distribution network at periodic intervals. For example, the entire PG is re-transmitted over the distribution network once per day so that receiving devices may update their locally stored copies of the PG to account for any changes to the PG that may have occurred.

Unfortunately, the PG may be very large and therefore may require substantial network bandwidth to transmit to a large number of receiving devices. Thus, periodic re-transmissions of the PG may be acceptable in wired distribution networks having sufficient bandwidth, but may not be acceptable in network environments having more limited bandwidth, such as in wireless networks. In such limited bandwidth environments, the re-transmission of the entire PG may require a substantial amount of available bandwidth and therefore negatively impact system performance. Furthermore, re-transmitting the entire PG to accommodate only minor state changes or revisions to the PG wastes bandwidth because information already locally stored at one or more devices is included in the re-transmission.

Therefore, what is needed is a system that operates to provide guide state information to devices in a distribution network, so that the devices may update their locally stored copies of a PG in an efficient manner. The system should also operate to minimize the amount of PG information that is transmitted to allow devices to update their locally stored copies of the PG while avoiding wasteful re-transmissions of PG information.

### SUMMARY

In one or more embodiments, a guide state notification system, comprising methods and apparatus, is provided that operates to provide guide state (PG) information to devices in a data network.

In one embodiment, a PG is maintained at a distribution server and contains a viewable list of scheduled content and/or services that are available for the devices to receive. A copy of the PG is maintained at authorized devices on a distribution network. When the PG at the server is updated, PG state information is transmitted to devices on the distribution network. When a device receives the PG state information, it is able to determine whether or not to retrieve all or selected portions of the PG with which to update its local copy. Thus, each device is able to maintain a current copy of the PG to present to the device user, thereby allowing the device user to view and/or subscribe to any of the content or services that may be available. As a result, embodiments of the guide state notification system avoid the burden and inefficiencies associated with re-transmitting the entire PG to all devices every time the PG changes.

In one embodiment, a method is provided for updating a program guide that comprises one or more sections. The method comprises determining that a selected section of the program guide has changed, and generating a guide state notification message that identifies the selected section of the program guide. The method also comprises transmitting the guide state notification message, and transmitting the selected section of the program guide.

In one embodiment, apparatus is provided for updating a program guide that comprises one or more sections. The apparatus comprises processing logic that operates to determine that a selected section of the program guide has changed, and guide state logic that operates to generate a guide state notification message that identifies the selected section of the program guide. The apparatus also comprises transmitting logic that operates to transmit the guide state notification message, and transmit the selected section of the program guide.

In one embodiment, a computer-readable media is provided that comprises instructions, which when executed by a processor, operate to update a program guide that comprises one or more sections. The computer-readable media comprises instructions for determining that a selected section of the program guide has changed, and instructions for generating a guide state notification message that identifies the selected section of the program guide. The computer-readable media also comprises instructions for transmitting the guide state notification message, and instructions for transmitting the selected section of the program guide.

In one embodiment, a method is provided for updating a program guide that comprises one or more sections. The method comprises receiving a guide state notification message that identifies a selected section of the program guide, and determining that a stored copy of the program guide needs to be updated. The method also comprises receiving the selected section of the program guide, and updating the stored copy of the program guide with the selected section of the program guide.

In one embodiment, apparatus is provided for updating a program guide that comprises one or more sections. The apparatus comprises logic configured to receive a guide state notification message that identifies a selected section of the program guide, and logic configured to determine that a stored copy of the program guide needs to be updated. The apparatus also comprises logic configured to receive the selected section of the program guide, and logic configured to update the stored copy of the program guide with the selected section of the program guide.

In one embodiment, a computer-readable media is provided that comprises instructions, which when executed by a processor, operate to update a program guide that comprises one or more sections. The computer-readable media comprises instructions for receiving a guide state notification message that identifies a selected section of the program guide, and instructions for determining that a stored copy of the program guide needs to be updated. The computer-readable media also comprises instructions for receiving the selected section of the program guide, and instructions for updating the stored copy of the program guide with the selected section of the program guide.

Other aspects of the embodiments will become apparent after review of the hereinafter set forth Brief Description of the Drawings, Detailed Description, and the Claims.

### BRIEF DESCRIPTION OF THE DRAWINGS

The foregoing aspects of the embodiments described herein will become more readily apparent by reference to the following detailed description when taken in conjunction with the accompanying drawings wherein:

FIG. 1 shows a network that comprises one embodiment of a guide state notification system;

FIG. 2 shows one embodiment of a server suitable for use in one embodiment of a guide state notification system;

FIG. 3 shows one embodiment of a guide state notification message for use with one embodiment of a guide state notification system;

FIG. 4 shows one embodiment of a timing diagram that illustrates the operation of one or more embodiments of a guide state notification system;

FIG. 5 shows one embodiment of a method for providing one embodiment of a guide state notification system;

FIG. 6 shows one embodiment of a device suitable for use in one embodiment of a guide state notification system; and

FIG. 7 shows one embodiment of a method for providing one embodiment of a guide state notification system.

### DETAILED DESCRIPTION

The following detailed description describes one or more embodiments of a guide state notification system. The system is especially well suited for use in wireless network environments, but may be used in any type of network environment, including but not limited to, communication networks, public networks, such as the Internet, private networks, such as virtual private networks (VPN), local area networks, wide area networks, long haul networks, or any other type of data or communication network.

In one or more embodiments, the guide state notification system operates to announce the current PG state to devices on a distribution network. For example, the PG is maintained at a distribution server and contains a viewable list of scheduled content and/or services that are available for the devices to receive. A copy of the PG is maintained at authorized devices on the distribution network. When the PG at the server is updated, PG state information is transmitted to devices on the distribution network. When a device receives the PG state information, it is able to determine whether or not to retrieve all or selected portions of the PG with which to update its local copy. Thus, each device is able to maintain a current copy of the PG to present to the device user, thereby allowing the device user to subscribe to any of the content or services that may be available. As a result, the guide state notification system avoids the burden and inefficiencies associated with re-transmitting the entire PG to all devices every time the PG changes.

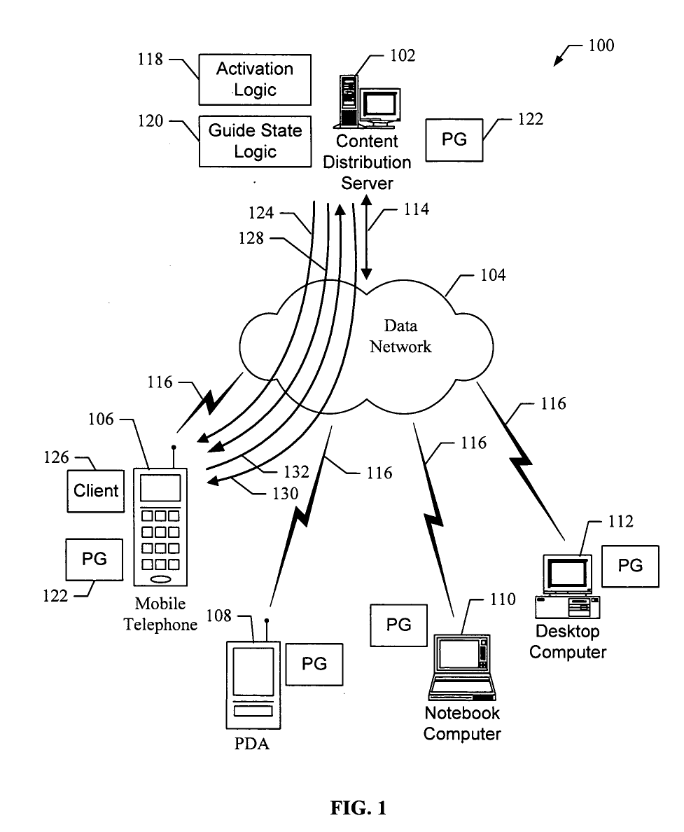

FIG. 1 shows a network 100 that comprises one embodiment of a guide state notification system. The network 100 comprises a content distribution server 102, a data network 104, and a collection of devices that comprise a mobile telephone 106, a personal digital assistant (PDA) 108, a notebook computer 110 and a desktop computer 112. The data network 104 may be any type and/or combination of wired and/or wireless networks that allow data to be transmitted between the server 102 and the devices. The server 102 communicates with the network 104 via the communication link 114, which may comprise any type of wired or wireless communication channel. The data network 104 provides wireless communication links 116 that allow data to be wirelessly transmitted between the network 104 and the devices 106, 108, 110, and 112. The wireless communication links 116 comprise any type of wireless communication technology. It should be noted that embodiments of the guide state notification system are applicable for use with virtually any type or number of devices and is not limited to operate with only the devices 106, 108, 110, and 112 shown in FIG. 1.

In one embodiment, the server 102 comprises activation logic 118, guide state logic 120, and a PG 122. The activation logic 118 operates to activate a device on the network 104 to allow the device to receive content and/or other available services. For example the activation logic 118 receives identification information from a device and operates to authenticate and/or authorize the device so that the device may request to receive available content and/or services.

As part of the activation process, the server 102 transmits the PG 122 to the activated device. For example, the PG 122 is transmitted to the device 106 as shown by path 124. The PG 122 is formatted and/or structured in accordance with one or more embodiments described herein. For example, in one embodiment, the PG is organized in sections where each section comprises a section identifier, section descriptor, listing of services, pricing information, scheduling, and any other relevant information. In one embodiment, a client 126 operates at the device 106 to process the PG 122 to display a list of available content and/or services to the device user. The client 126 may be downloaded to the device from the server 102 during the activation process, provided by a third party or installed on the device during manufacture. The client 126 operates to present any or all of the available information in the PG 122 to the user of the device 106. Thus, it is possible for the device user to see a variety of information that may be used to select content and/or services for subscription. The device user may then select to receive any of the listed content and/or services.

In one embodiment, the PG 122 at the content distribution server 102 is periodically updated to reflect changes in the available content and/or services. When this occurs, the guide state logic 120 operates to generate one or more guide state notification messages that are transmitted to the devices on the network 104 to notify them of the guide state changes. For example the guide state logic 120 transmits guide state notification messages to the device 106 as shown by path 128. The guide state notification messages indicate that all or selected sections of the PG 122 have been updated.

In one embodiment, after the guide state notification messages have been transmitted, the server 102 broadcasts the updates to the PG 122 on the network 104 as shown by path 130. The devices on the network 104 process the guide state notification messages to determine whether their local copy of the PG 122 is current or needs to be updated. If a device determines that its local PG needs to be updated, it listens to transmissions from the server 102 and receives selected portions of the PG 122 with which to update its local copy. The device is then able to update its local PG 122 with the newly received PG updates.

In another embodiment, the device 102 processes the guide state notification messages, and transmits one or more requests to the server 102 to download all or identified sections of the PG 122, as shown by path 132. The server 102 responds by transmitting the requested sections of the PG 122 to the requesting device.

As a result, embodiments of the guide state notification system operate to allow a local copy of the PG to be maintained and updated at devices on the network 104. Additionally, because the devices receive only the portions of the PG that they need, updates to the PG are provided to the devices in a manner that conserves network bandwidth and avoids re-transmission and reception of the entire PG every time the PG information is updated.

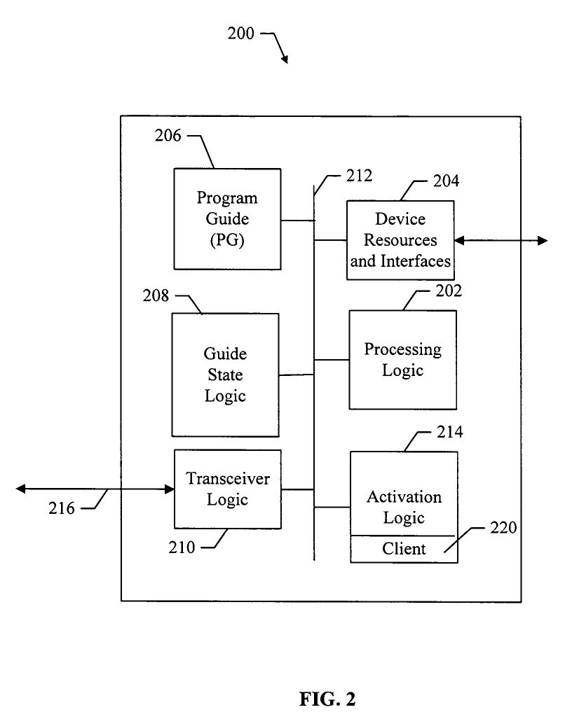

FIG. 2 shows one embodiment of a server 200 suitable for use in one embodiment of a guide state notification system. For example, the server 200 may be used as the server 102 in FIG. 1. The server 200 comprises processing logic 202, device resources and interfaces 204, and transceiver logic 210, all coupled to an internal data bus 212. The server 200 also comprises activation logic 214, PG 206, and guide state logic 208, which are also coupled to the data bus 212.

In one or more embodiments, the processing logic 202 comprises a CPU, processor, gate array, hardware logic, memory elements, virtual machine, software, and/or any combination of hardware and software. Thus, the processing logic 202 generally comprises logic to execute machine-readable instructions and to control one or more other functional elements of the server 200 via the internal data bus 212.

The device resources and interfaces 204 comprise hardware and/or software that allow the server 200 to communicate with internal and external systems. For example, the internal systems may include mass storage systems, memory, display driver, modem, or other internal device resources. The external systems may include user interface devices, printers, disk drives, or other local devices or systems.

The transceiver logic 210 comprises hardware logic and/or software that operates to allow the server 200 to transmit and receive data and/or other information with remote devices or systems using communication channel 216. For example, in one embodiment, the communication channel 216 comprises any suitable type of communication link to allow the server 200 to communicate with a data network.

The activation logic 214 comprises a CPU, processor, gate array, hardware logic, memory elements, virtual machine, software, and/or any combination of hardware and software. The activation logic 214 operates to activate a device to allow the device to select and receive content and/or services described in the PG 206. In one embodiment, the activation logic 214 transmits a client program 220 to the device during the activation process. The client program 220 runs on the device to receive the PG 206 and display information about available content or services to the device user. Thus, the activation logic 214 operates to authenticate a device, download the client 220, and download the PG 206 for rendering on the device by the client 220.

The PG 206 comprises information in any suitable format that describes content and/or services that are available for devices to receive. For example, the PG 206 may be stored in a local memory of the server 200 and may comprise information such as content or service identifiers, scheduling information, pricing, and/or any other type of relevant information. In one embodiment, the PG 206 comprises one or more identifiable sections that are updated by the processing logic 202 as changes are made to the available content or services.

The guide state logic 208 comprises hardware and/or software that operates to generate guide state notification messages that identify and/or describe changes to the PG 206. For example, when the processing logic 202 updates the PG 206, the guide state logic 208 is notified about the changes. The guide state logic 208 then generates one or more guide state notification messages that are transmitted to devices activated with the server 200 So that these devices are notified about the changes to the PG 206.

In one embodiment, as part of the guide state notification message, a broadcast indicator is provided that indicates when the section of the PG identified in the message will be broadcast. For example, in one embodiment, the broadcast indicator comprises one bit to indicate that the section will be broadcast and a time indicator that indicates when the broadcast will occur. Thus, devices wishing to update their local copy of the PG can listen for the broadcast at the designated time to receive the updated section of the PG.

In one embodiment, the guide state notification system comprises program instructions stored on a computer-readable media, which when executed by a processor, for instance, the processing logic 202, provides the functions of the server 200 described herein. For example, the program instructions may be loaded into the server 200 from a computer-readable media, such as a floppy disk, CDROM, memory card, FLASH memory device, RAM, ROM, or any other type of memory device or computer-readable media that interfaces to the server 200 through the device resources 204. In another embodiment, the instructions may be downloaded into the server 200 from an external device or network resource that interfaces to the server 200 through the transceiver logic 210. The program instructions, when executed by the processing logic 202, provide one or more embodiments of a guide state notification system as described herein.

During operation of one embodiment of the guide state notification system, the server 200 performs one or more of the following functions.
1. A program guide is defined in one or more identifiable sections (i.e., service levels, blocks, time intervals, etc.) and delivered to devices on a data network during an activation process.
2. When one or more sections of the program guide are updated or changed, one or more guide state notification messages are generated that identify the sections of the program guide that have been changed.

3. The guide state notification messages are transmitted to devices in the data network. The devices process the guide state notification messages to determine if their local versions of the PG need to be updated.

4. In one embodiment, one or more sections of the PG are broadcast from the server. These sections may comprise the entire PG or selected sections of the PG. The devices receive selected sections of the broadcasted PG and update their local copies of the PG as necessary.

5. In another embodiment, in response to receiving the guide state notification messages, the devices transmit requests to the server for one or more sections of the PG. The server responds by transmitting the requested sections of the PG, which are used to update the local copies of the PG at the requesting devices.

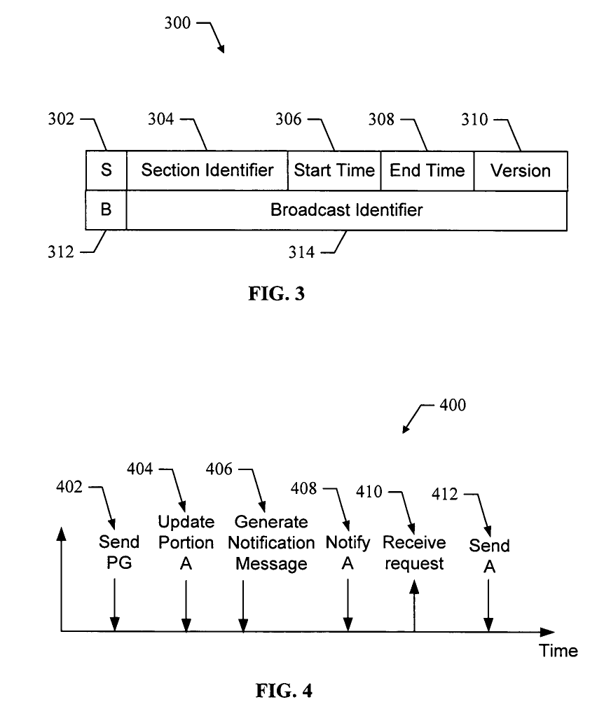

FIG. 3 shows one embodiment of a guide state notification message 300 for use in one embodiment of a guide state notification system. The guide state notification message 300 comprises a service level 302, section identifier 304, start time 306, end time 308, and a version 310. The guide state notification message 300 also comprises a broadcast indicator 312 and a broadcast identifier 314. It should also be noted that the guide state notification message 300 represents only one embodiment, and that it is possible to include less or more information in other embodiments of the guide state notification message 300.

In one embodiment, the service level 302 comprises one bit that indicates whether the guide state notification message 300 pertains to a particular section of the PG or all sections of the PG. If the service level 302 is a “1” then the guide state notification message 300 pertains to all sections of the PG that are identified by the start time 306, the end time 308 and the version 310. In this case, the section identifier 304 comprises all “0.” If the service level 302 is a “0”, then the guide state notification message 300 pertains to a section of the PG identified by the section identifier 304.

The start time 306 and end time 308 indicate the start time and end time of the identified PG section. The version 310 indicates the current version of the identified PG section. For example, if a section of the PG relating to particular content or service has changed, the guide state logic 208 will increment the version 310 by one. If the service level 302 is set to “0”, and if there is a change in one section of the PG, the guide state logic 208 will increment the version 310 by 1. When a device receives the guide state notification message 300, it uses the information in the message to determine whether it has the latest version of the PG or section of the PG. If a device does not have the latest version, it operates according to one or more embodiments to obtain the latest version with which to update its local copy.

The broadcast indicator 312 comprises one bit that indicates whether the updates to the PG described by the guide state notification message will be broadcast for reception by interested devices. The broadcast identifier 314 identifies a time when the broadcast will occur. For example, if the broadcast indicator is a “1” a broadcast of the updates to the PG will be performed at a time provided by the broadcast indicator 314. In one embodiment, the time parameters provided in the guide state notification message 300 are based on a national or global time standard.

FIG. 4 shows one embodiment of a timing diagram 400 that illustrates the operation of one or more embodiments of a guide state notification system. For example, the timing diagram 400 illustrates the operation of the server 200 in one or more embodiments of a guide state notification system.

It will be assumed that a PG is initially transmitted to all activated devices in the network. For example, all activated devices have the latest PG at a time indicated by 402. At a time indicated by 404, all or selected sections of the PG are updated or otherwise changed. For example, the processing logic 202 may update the PG 206 with information about new content or services that have become available. For the purpose of this description, it will be assumed that portion “A” of the PG is updated at 404.

At a time indicated by 406, one or more guide state notification messages are generated. For example, the guide state logic 208 operates to generate one or more guide state notification messages in response to the changes to portion A. In one embodiment, the guide state notification messages are formatted as shown in FIG. 3.

At a time indicated by 408, the guide state notification messages are transmitted to devices in the network. For example, the guide state notification messages are transmitted by the transceiver logic 210 to devices in the network. In one embodiment, the guide state notification messages are broadcast to the devices, and in another embodiment, the guide state notification messages are unicast to the devices. In one embodiment, if the updates to the PG are to be broadcast, then the guide state notification messages include a broadcast indicator 312 and a broadcast identifier 314 that indicate that updates to the PG will be broadcast at a selected time.

In response to receiving the guide state notification messages, each device determines whether or not its local copy of the PG needs to be updated. In one embodiment, the server broadcasts sections of the PG identified in the notification messages at time 412. Any device wishing to receive updated program guide information may receive the broadcast at time 412 and update its local copy of the PG as necessary.

In another embodiment, if a device decides to update its local copy of the PG, it transmits a request to the server for the sections of the PG it desires to update. For example, the server receives a request for portion A of the PG at time 410. At time 412, the server responds by transmitting the portion A of the PG to the requesting device.

It should be noted that the timing diagram shown in FIG. 4 illustrates the operation of one embodiment, and that other embodiments of the guide state notification system may operate according to different timing criteria. Thus, other implementations may operate under different timing conditions within the scope of the embodiments.

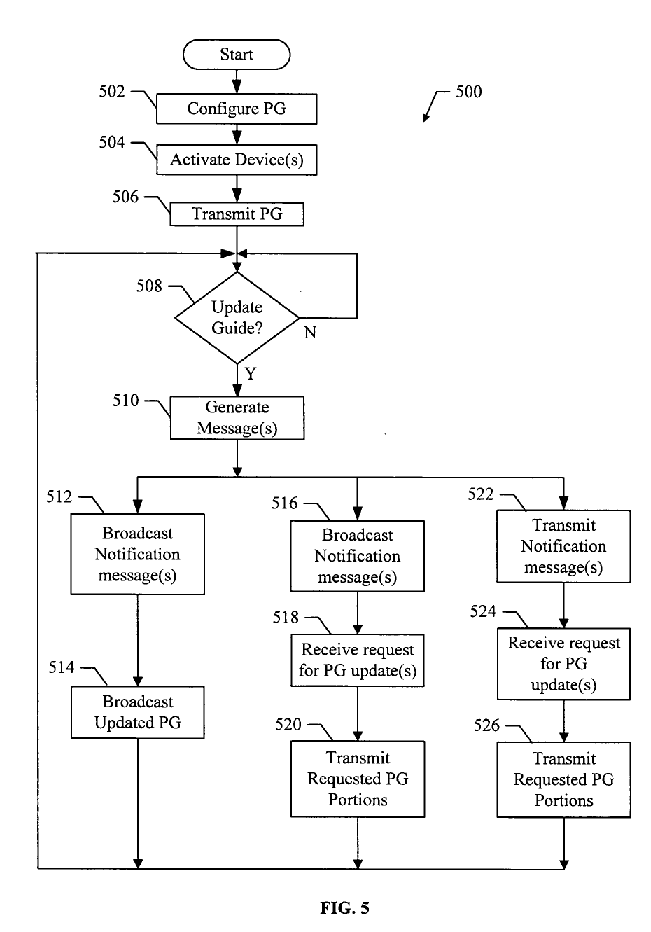

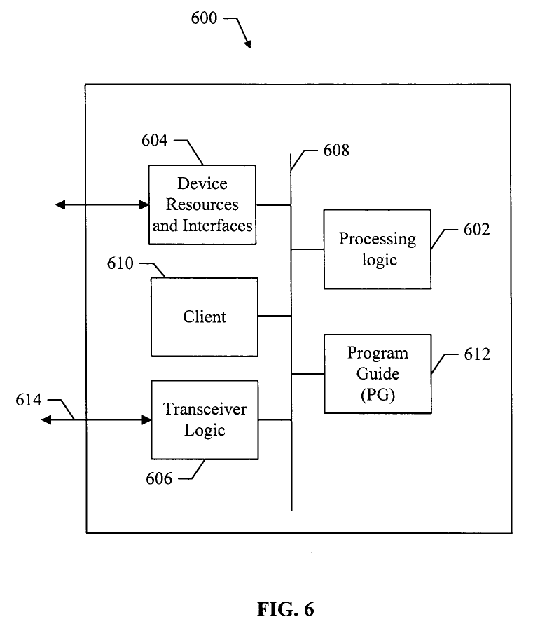

FIG. 5 shows one embodiment of a method 500 for providing one embodiment of a guide state notification system. For clarity, the method 500 is described herein with reference to the server 200 in FIG. 2.

At block 502, a PG is configured to have one or more sections. For example, the PG may be configured where each section defines a particular service, group of services, block of time, or any other suitable configuration, and where each identifiable section has an associated version number and/or other associated parameters.

At block 504, one or more devices are activated. Once activated, a device is able to receive available content and/or services. For example, during the activation process a device identifies itself to the server and receives a client program. The client program operates to render information from the PG to allow the device user to view available content and/or services.

At block 506, the PG is transmitted to the device. For example, as part of the activation process, the PG is transmitted to the device and rendered by the client program residing on the device. In one embodiment, the activation logic 214 operates to transmit the client 220 and PG 206 to the device through the transceiver logic 210.

At block 508, a test is performed to determine if there are updates or changes to the PG. For example, the processing logic 202 operates to update the PG 206 as changes to the available content or services occur. If there are no updates to the PG 206, the method returns to block 508 to test for PG updates at a later time. If there are updates to the PG 206, the method proceeds to block 510.

At block 510, one or more guide state notification messages are generated in response to the change in the PG. For example, the guide state logic 208 operates to generate the guide state notification messages as described above. In one embodiment, the PG comprises one or more identifiable sections and the guide state notification messages are formatted as shown in FIG. 3 to describe which of the PG sections have been updated. In one embodiment, multiple guide state notification messages may be generated where each message describe one section of the PG that has been changed.

Once the guide state notification messages are generated at block 510, the guide state notification system utilizes one of several methods to transmit the guide state notification messages to devices on the network. The following description of the method 500 illustrates three ways in which the messages and corresponding responses may be transmitted, however, it should be noted that other transmission techniques are possible within the scope of the embodiments. For example, the guide state messages may be transmitted to devices utilizing an out-of-band communication channel.

At block 512, a first method begins for transmitting the guide state notification messages. The guide state notification messages are broadcast over the network so that any activated device on the network may receive the broadcast and obtain the messages. For example, the guide state logic 208 passes the guide state notification messages to the transceiver logic 210, which in turn, broadcasts the messages over the data network through the communication channel 216.

At block 514, the updated sections of the PG are broadcast over the network according to the information in the guide state notification messages broadcast at block 512. For example, the processing logic 202 passes the updated portions of the PG to the transceiver logic 210, which in turn, broadcasts the information over the data network using the communication channel 216. Devices wishing to update their local copies of the PG receive the broadcast and update their local copies accordingly. The method then proceeds to block 508 to determine if there are any more updates to the PG.

At block 516, a second method begins for transmitting the guide state notification messages to devices on the network and receiving associated responses. The guide state notification messages are broadcast over the network as done at block 512. For example, the guide state logic 208 passes the guide state notification messages to the transceiver logic 210, which in turn, broadcasts the messages over the data network through the communication channel 216.

At block 518, the server receives one or more requests for selected sections of the updated PG. For example, devices on the network receive the broadcasted guide state notification messages and determine whether their local copies of the PG need to be updated. When a device determines that its local copy of the PG needs to be updated, it transmits a request to the server to obtain the desired sections of the updated PG. In one embodiment, the server receives the requests using the transceiver logic 210, which passes the requests to the processing logic 202.

At block 520, the requested sections of the updated PG are transmitted to requesting devices. In one embodiment, the processing logic 202 obtains the updated sections of the PG 206 and controls the transceiver logic 210 to transmit these portions to the requesting devices, respectively. For example, in one embodiment, the updated sections of the PG are transmitted to devices utilizing unicast transmissions through channel 216. Once all the requests are fulfilled, the method proceeds to block 508 to determine if more updates to the PG have occurred.

At block 522, a third method begins for transmitting the guide state notification messages to devices on the network and receiving associated responses. The guide state notification messages are transmitted over the network to devices using unicast transmissions. For example, the guide state logic 208 passes the guide state notification messages to the transceiver logic 210, which in turn, unicasts the messages over the data network to devices using the communication channel 216.

At block 524, the server receives one or more requests for selected sections of the updated PG. For example, devices on the network receive the unicasted guide state notification messages and determine whether their local copies of the PG need to be updated. When a device determines that its local copy of the PG needs to be updated, it transmits a request to the server to obtain the desired sections of the updated PG. In one embodiment, the server receives the requests using the transceiver logic 210, which passes the requests to the processing logic 202.

At block 526, the requested sections of the updated PG are transmitted to requesting devices. In one embodiment, the processing logic 202 obtains the updated sections of the PG 206 and controls the transceiver logic 210 to transmit these sections to the requesting devices, respectively. For example, in one embodiment, the updated sections of the PG are transmitted to devices utilizing unicast transmissions through the channel 216. Once all the requests are fulfilled, the method proceeds to block 508 to determine if more updates to the PG have occurred.

Thus, the method 500 operates to provide a guide state notification system that allows devices to efficiently maintain an updated local copy of a PG. It should be noted that the method 500 represents just one implementation and that other implementations are possible within the scope of the embodiments.

FIG. 6 shows one embodiment of a device 600 suitable for use in one embodiment of a guide state notification system. For example, the device 600 may be the device 106 shown in FIG. 1. The device 600 comprises processing logic 602, device resources and interfaces 604, and transceiver logic 606, all coupled to a data bus 608. The device 600 also comprises a client 610 and a PG 612, which are also coupled to the data bus 608.

In one or more embodiments, the processing logic 602 comprises a CPU, processor, gate array, hardware logic, memory elements, virtual machine, software, and/or any combination of hardware and software. Thus, the processing logic 602 generally comprises logic configured to execute machine-readable instructions and to control one or more other functional elements of the device 600 via the internal data bus 608.

The device resources and interfaces 604 comprise hardware and/or software that allow the device 600 to communicate with internal and external systems. For example, internal systems may include mass storage systems, memory, display driver, modem, or other internal device resources. The external systems may include user interface devices, printers, disk drives, or other local devices or systems.

The transceiver logic 606 comprises hardware and/or software that operate to allow the device 600 to transmit and receive data and/or other information with external devices or systems through communication channel 614. For example the communication channel 614 may comprise a network communication link, a wireless communication link, or any other type of communication link.

During operation, the device 600 is activated so that it may receive available content or services over a data network. For example, in one embodiment, the device 600 identifies itself to a content distribution server during an activation process. As part of the activation process, the device receives the client 610 and the PG 612. The PG 612 contains information that identifies content or services available for the device 600 to receive. The client 610 operates to render information in the PG 612 on the device 600 using the device resources and interfaces 604. For example the client 610 renders information in the PG 612 on a display screen that is part of the device resources and interfaces 604. The client 610 also receives user input through the device resources and interfaces 604 so that a device user may select content or services.

In one embodiment, the client 610 receives guide state notification messages through the transceiver logic 606. For example, the messages may be broadcast or unicast to the device 600 and received by the transceiver logic 606. The guide state notification messages identify updates to the PG 612. In one embodiment, the client 610 processes the guide state notification messages to determine whether the local copy of the PG 612 needs to be updated. For example, in one embodiment, the guide state notification messages are formatted as shown in FIG. 3 and include a section identifier, start time, end time, and version number. The client 610 operates to compare the information in the guide state notification messages to locally stored information that is part of the existing PG 612. If the client 610 determines from the guide state notification messages that one or more sections of the local copy of the PG 612 needs to be updated, the client 610 operates to receive the updated sections of the PG in one of several ways. For example, the updated sections of the PG may be broadcasted at a time indicated in the guide state notification messages, so that the transceiver logic 606 may receive the broadcasts and pass the updated sections to the client 610, which in turn updates the local copy of the PG 612.

In another embodiment, the client 610 determines which sections of the PG 612 need to be updated based on the received guide state notification messages, and transmits a request to a distribution server to obtain the desired updated sections of the PG. For example, the request may be formatted using any suitable format and comprise information such as a requesting device identifier, section identifier, version number, and/or any other suitable information.

In one embodiment, the device 600 performs one or more of the following functions in one or more embodiments of a guide state notification system. It should be noted that the following functions might be changed, rearranged, modified, added to, deleted, or otherwise adjusted within the scope of the embodiments.
1. The device is activated for operation with a content distribution system to receive content or services. As part of the activation process, a client and PG are transmitted to the device.
2. One or more guide state notification messages are received by the device and used to determine if one or more sections of the locally stored PG need to be updated.
3. In one embodiment, if the device determines that one or more sections of the locally stored PG need to be updated, the device listens to a broadcast from the distribution system to obtain the updated sections of the PG that it needs to update its local copy.
4. In another embodiment, the device transmits one or more request messages to the server to obtain the updated sections of the PG it needs.
5. In response to the request, the server transmits the updated sections of the PG to the device.
6. The device uses the received updated sections of the PG to update its local copy of the PG.

In one embodiment, the guide state notification system comprises program instructions stored on a computer-readable media, which when executed by a processor, such as the processing logic 602, provides the functions of the guide state notification system as described herein. For example, instructions may be loaded into the device 600 from a computer-readable media, such as a floppy disk, CDROM, memory card, FLASH memory device, RAM, ROM, or any other type of memory device or computer-readable media that interfaces to the device 600 through the device resources and interfaces 604. In another embodiment, the instructions may be downloaded into the device 600 from a network resource that interfaces to the device 600 through the transceiver logic 606. The instructions, when executed by the processing logic 602, provide one or more embodiments of a guide state notification system as described herein.

It should be noted that the device 600 represents just one implementation and that other implementations are possible within the scope of the embodiments.

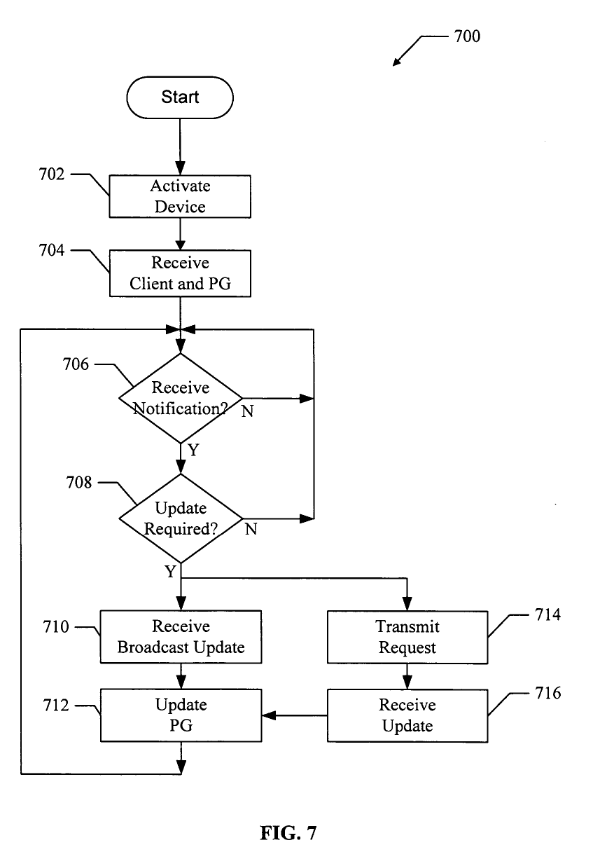

FIG. 7 shows one embodiment of a method 700 for providing one embodiment of a guide state notification system. For clarity, the method 700 is described herein with reference to the device 600 shown in FIG. 6.

At block 702, the device goes through an activation process that allows the device to receive available content or services. For example, in one embodiment, the processing logic 602 identifies the device to a distribution server so that the device may be authenticated and authorized to receive available content or services.

At block 704, the device receives a client and PG. For example, as part of the activation process, the device receives the client 610 and PG 612 from a distribution server. The client 610 executes on the device to render information in the PG 612 that allows the device user to view available content or services.

At block 706, a test is performed to determine if one or more guide state notification messages have been received. For example, in one embodiment, the guide state notification messages may be received in a broadcast transmission from a distribution server. In another embodiment, the guide state notification messages may be received in a unicast transmission from the server. For example, the transceiver logic 606 receives the guide state notification messages and passes the messages to the client 610 for processing. If no guide state notification messages are received the method proceeds back to block 706. If one or more guide state notification messages are received, the method proceeds to block 708.

At block 708, a test is performed to determine if any updates to the local PG are needed based on the received guide state notification messages. For example, in one embodiment, the client 610 processes the received guide state notification messages to determine if the local copy of the PG 612 needs to be updated. The guide state notification messages indicate that all or selected sections of the PG have been updated at the server. The client 610 compares information in the guide state notification messages to information locally stored at the device. If the client 610 determines that the locally stored copy of the PG already includes the updated sections of the PG identified in the guide state notification messages, then no updates are required and the method proceeds to block 706. If the client 610 determines that the locally stored PG does not include the updated sections of the PG identified in the guide state notification messages, then the method proceeds to either block 710 or 714.

In one embodiment, the guide state notification messages are formatted as shown in FIG. 3, and the client 610 operates to compare the section identifier, start time, end time, and/or version number of the sections identified in the guide state notification messages with information contained in the locally stored copy of the PG. If the information in the guide state notification messages is different from information that is locally stored, then the client 610 determines that the locally stored copy of the PG needs to be updated.

In order to update the local copy of the PG, the method 700 provides two techniques. One technique starts at block 710 and another technique starts at block 714. Both techniques are described herein, however, it should be noted that other techniques to update the local copy of the PG are possible within the scope of the embodiments.

At block 710, a broadcast is received that comprises the updated sections of the PG. For example, the server broadcasts the updated sections of the PG so that any activated device that needs to update its locally stored copy of the PG may receive the broadcast. For example, the transceiver logic 606 receives the broadcast and passes the received PG sections to the client logic 610. In one embodiment, the broadcast identifier 314 in the guide state notification message indicates to the device when the broadcast will occur.

At block 712, the local copy of the PG is updated with information received in the broadcast. For example, the client 610 operates to update the local copy of the PG 612 with the received updated sections of the PG contained in the broadcast. The method then proceeds to block 706.

At block 714 a second technique for updating the locally stored copy of the PG begins. A request is transmitted to the server to obtain the sections of the PG that need to be updated. For example, the client 610 transmits the request through the transceiver logic 606 and the channel 614. In one embodiment, the request identifies the device 600 and the desired PG sections. The request may be formatted using any suitable format and contain any information that may be necessary to obtain the desired updated PG sections.

At block 716, the device receives updated sections of the PG. For example, in response to the request transmitted at block 714, the server transmits the requested sections of the PG to the device. In one embodiment, the updated sections of the PG are transmitted in a unicast transmission to the device that is received by the transceiver logic 606 and passed to the client logic 610. The method then proceeds to block 712 where the client 610 updates the locally stored copy of the PG.

Thus, the method 700 operates to provide a guide state notification system that allows a device to efficiently maintain an updated local copy of a PG. It should be noted that the method 700 represents just one implementation and that other implementations are possible within the scope of the embodiments.

Accordingly, while one or more embodiments of a guide state notification system have been illustrated and described herein, it will be appreciated that various changes can be made to the embodiments without departing from their spirit or essential characteristics. Therefore, the disclosures and descriptions herein are intended to be illustrative, but not limiting, of the scope of the invention, which is set forth in the following claims.

What is claimed is:

1. A method for updating a program guide that comprises one or more sections, the method comprising:
determining that a selected section of the program guide has changed;
generating a program guide state notification message that identifies the selected section of the program guide;
transmitting the program guide state notification message; and
transmitting the selected section of the program guide.

2. The method of claim 1, wherein said transmitting the guide state notification message comprises broadcasting the guide state notification message over a data network.

3. The method of claim 1, wherein said transmitting the guide state notification message comprises transmitting the guide state notification message in a unicast transmission over a data network.

4. The method of claim 1, wherein said transmitting the selected section of the program guide comprises broadcasting the selected section of the program guide over a data network.

5. The method of claim 1, wherein said transmitting the selected section of the program guide comprises transmitting the selected section of the program guide in a unicast transmission over a data network.

6. The method of claim 1, further comprising receiving a request for the selected section of the program guide.

7. The method of claim 1, wherein said generating the guide state notification message comprises generating the guide state notification message to comprise a version identifier of the selected section of the program guide.

8. The method of claim 1, wherein said generating the guide state notification message comprises generating the guide state notification message to comprise a broadcast identifier that identifies when the selected section of the program guide is to be broadcast over a data network.

9. Apparatus for updating a program guide that comprises one or more sections, the apparatus comprising:
processing logic that operates to determine that a selected section of the program guide has changed;
guide state logic that operates to generate a guide state notification message that identifies the selected section of the program guide; and
transmitting logic that operates to transmit the guide state notification message and transmit the selected section of the program guide.

10. The apparatus of claim 9, wherein said transmitting logic comprises logic configured to broadcast the guide state notification message over a data network.

11. The apparatus of claim 9, wherein said transmitting logic comprises logic configured to transmit the guide state notification message in a unicast transmission over a data network.

12. The apparatus of claim 9, wherein said transmitting logic comprises logic configured to broadcast the selected section of the program guide over a data network.

13. The apparatus of claim 9, wherein said transmitting logic comprises logic configured to transmit the selected section of the program guide in a unicast transmission over a data network.

14. The apparatus of claim 9, further comprising receive logic that operates to receive a request for the selected section of the program guide.

15. The apparatus of claim 9, wherein said guide state logic comprises logic configured to generate the guide state notification message to comprise a version identifier of the selected section of the program guide.

16. The apparatus of claim 9, wherein said guide state logic comprises logic configured to generate the guide state notification message to comprise a broadcast identifier that identifies when the selected section of the program guide is to be broadcast over a data network.

17. Apparatus for updating a program guide that comprises one or more sections, the apparatus comprising:
means for determining that a selected section of the program guide has changed;
means for generating a program guide state notification message that identifies the selected section of the program guide;
means for transmitting the program guide state notification message; and
means for transmitting the selected section of the program guide.

18. The apparatus of claim 17, wherein said means for transmitting the guide state notification message comprises means for broadcasting the guide state notification message over a data network.

19. The apparatus of claim 17, wherein said means for transmitting the guide state notification message comprises means for transmitting the guide state notification message in a unicast transmission over a data network.

20. The apparatus of claim 17, wherein said means for transmitting the selected section of the program guide comprises means for broadcasting the selected section of the program guide over a data network.

21. The apparatus of claim 17, wherein said means for transmitting the selected section of the program guide comprises means for transmitting the selected section of the program guide in a unicast transmission over a data network.

22. The apparatus of claim 17, further comprising means for receiving a request for the selected section of the program guide.

23. The apparatus of claim 17, wherein said means for generating the guide state notification message comprises means for generating the guide state notification message to comprise a version identifier of the selected section of the program guide.

24. The apparatus of claim 17, wherein said means for generating the guide state notification message comprises means for generating the guide state notification message to comprise a broadcast identifier that identifies when the selected section of the program guide is to be broadcast over a data network.

25. A computer-readable media comprising instructions, which when executed by a processor, operate to update a program guide that comprises one or more sections, the computer-readable media comprising:
instructions for determining that a selected section of the program guide has changed;
instructions for generating a program guide state notification message that identifies the selected section of the program guide;
instructions for transmitting the program guide state notification message; and
instructions for transmitting the selected section of the program guide.

26. The computer-readable media of claim 25, wherein said instructions for transmitting the guide state notification message comprise instructions for broadcasting the guide state notification message over a data network.

27. The computer-readable media of claim 25, wherein said instructions for transmitting the guide state notification message comprise instructions for transmitting the guide state notification message in a unicast transmission over a data network.

28. The computer-readable media of claim 25, wherein said instructions for transmitting the selected section of the program guide comprise instructions for broadcasting the selected section of the program guide over a data network.

29. The computer-readable media of claim 25, wherein said instructions for transmitting the selected section of the program guide comprise instructions for transmitting the selected section of the program guide in a unicast transmission over a data network.

30. The computer-readable media of claim 25, further comprising instructions for receiving a request for the selected section of the program guide.

31. The computer-readable media of claim 25, wherein said instructions for generating the guide state notification message comprise instructions for generating the guide state notification message to comprise a version identifier of the selected section of the program guide.

32. The computer-readable media of claim 25, wherein said instructions for generating the guide state notification message comprise instructions for generating the guide state notification message to comprise a broadcast identifier that identifies when the selected section of the program guide is to be broadcast over a data network.

33. Apparatus comprising at least one processor configured to implement a method comprising:
determining that a selected section of the program guide has changed;
generating a program guide state notification message that identifies the selected section of the program guide;
transmitting the program guide state notification message; and
transmitting the selected section of the program guide.

34. The apparatus of claim 33, wherein said transmitting the guide state notification message comprises broadcasting the guide state notification message over a data network.

35. The apparatus of claim 33, wherein said transmitting the guide state notification message comprises transmitting the guide state notification message in a unicast transmission over a data network.

36. The apparatus of claim 33, wherein said transmitting the selected section of the program guide comprises broadcasting the selected section of the program guide over a data network.

37. The apparatus of claim 33, wherein said transmitting the selected section of the program guide comprises transmitting the selected section of the program guide in a unicast transmission over a data network.

38. The apparatus of claim 33, further comprising receiving a request for the selected section of the program guide.

39. The apparatus of claim 33, wherein said generating the guide state notification message comprises generating the guide state notification message to comprise a version identifier of the selected section of the program guide.

40. The apparatus of claim 33, wherein said generating the guide state notification message comprises generating the guide state notification message to comprise a broadcast identifier that identifies when the selected section of the program guide is to be broadcast over a data network.

41. A method for updating a program guide that comprises one or more sections, the method comprising:
receiving a program guide state notification message that identifies a selected section of the program guide;
determining that a stored copy of the program guide needs to be updated;
receiving the selected section of the program guide; and
updating the stored copy of the program guide with the selected section of the program guide.

42. The method of claim 41, wherein said receiving the guide state notification message comprises receiving a broadcast of the guide state notification message over a data network.

43. The method of claim 41, wherein said receiving the guide state notification message comprises receiving the guide state notification message in a unicast transmission over a data network.

44. The method of claim 41, wherein said receiving the selected section of the program guide comprises receiving a broadcast of the selected section of the program guide over a data network.

45. The method of claim 41, wherein said receiving the selected section of the program guide comprises receiving the selected section of the program guide in a unicast transmission over a data network.

46. The method of claim 41, further comprising transmitting a request for the selected section of the program guide.

47. The method of claim 41, wherein said receiving the guide state notification message comprises receiving a version identifier of the selected section of the program guide.

48. The method of claim 47, wherein said determining comprises comparing the version identifier with a stored version identifier.

49. The method of claim 41, wherein said receiving the guide state notification message comprises receiving a broadcast identifier that identifies when the selected section of the program guide is to be broadcast over a data network.

50. The method of claim 41, wherein said receiving the guide state notification message comprises receiving the guide state notification message over a wireless data network.

51. Apparatus for updating a program guide that comprises one or more sections, the apparatus comprising:
logic configured to receive a program guide state notification message that identifies a selected section of the program guide;
logic configured to determine that a stored copy of the program guide needs to be updated;
logic configured to receive the selected section of the program guide; and
logic configured to update the stored copy of the program guide with the selected section of the program guide.

52. The apparatus of claim 51, wherein said logic configured to receive the guide state notification message comprises logic configured to receive a broadcast of the guide state notification message over a data network.

53. The apparatus of claim 51, wherein said logic configured to receive the guide state notification message comprises logic configured to receive the guide state notification message in a unicast transmission over a data network.

54. The apparatus of claim 51, wherein said logic configured to receive the selected section of the program guide comprises logic configured to receive a broadcast of the selected section of the program guide over a data network.

55. The apparatus of claim 51, wherein said logic configured to receive the selected section of the program guide comprises logic configured to receive the selected section of the program guide in a unicast transmission over a data network.

56. The apparatus of claim 51, further comprising logic configured to transmit a request for the selected section of the program guide.

57. The apparatus of claim 51, wherein said logic configured to receive the guide state notification message comprises logic configured to receive a version identifier of the selected section of the program guide.

58. The apparatus of claim 57, wherein said logic configured to determine comprises logic configured to compare the version identifier with a stored version identifier.

59. The apparatus of claim 51, wherein said logic configured to receive the guide state notification message comprises logic configured to receive a broadcast identifier that identifies when the selected section of the program guide is to be broadcast over a data network.

60. The apparatus of claim 51, wherein said logic configured to receive the guide state notification message comprises logic configured to receive the guide state notification message over a wireless data network.

61. Apparatus for updating a program guide that comprises one or more sections, the apparatus comprising:
means for receiving a program guide state notification message that identifies a selected section of the program guide;
means for determining that a stored copy of the program guide needs to be updated;
means for receiving the selected section of the program guide; and
means for updating the stored copy of the program guide with the selected section of the program guide.

62. The apparatus of claim 61, wherein said means for receiving the guide state notification message comprises means for receiving a broadcast of the guide state notification message over a data network.

63. The apparatus of claim 61, wherein said means for receiving the guide state notification message comprises means for receiving the guide state notification message in a unicast transmission over a data network.

64. The apparatus of claim 61, wherein said means for receiving the selected section of the program guide comprises means for receiving a broadcast of the selected section of the program guide over a data network.

65. The apparatus of claim 61, wherein said means for receiving the selected section of the program guide comprises means for receiving the selected section of the program guide in a unicast transmission over a data network.

66. The apparatus of claim 61, further comprising means for transmitting a request for the selected section of the program guide.

67. The apparatus of claim 61, wherein said means for receiving the guide state notification message comprises means for receiving a version identifier of the selected section of the program guide.

68. The apparatus of claim 67, wherein said means for determining comprises means for comparing the version identifier with a stored version identifier.

69. The apparatus of claim 61, wherein said means for receiving the guide state notification message comprises means for receiving a broadcast identifier that identifies when the selected section of the program guide is to be broadcast over a data network.

70. The apparatus of claim 61, wherein said means for receiving the guide state notification message comprises means for receiving the guide state notification message over a wireless data network.

71. A computer-readable media comprising instructions, which when executed by a processor, operate to update a program guide that comprises one or more sections, the computer-readable media comprising:
instructions for receiving a program guide state notification message that identifies a selected section of the program guide;
instructions for determining that a stored copy of the program guide needs to be updated;
instructions for receiving the selected section of the program guide; and
instructions for updating the stored copy of the program guide with the selected section of the program guide.

72. The computer-readable media of claim 71, wherein said instructions for receiving the guide state notification message comprise instructions for receiving a broadcast of the guide state notification message over a data network.

73. The computer-readable media of claim 71, wherein said instructions for receiving the guide state notification message comprise instructions for receiving the guide state notification message in a unicast transmission over a data network.

74. The computer-readable media of claim 71, wherein said instructions for receiving the selected section of the program guide comprise instructions for receiving a broadcast of the selected section of the program guide over a data network.

75. The computer-readable media of claim 71, wherein said instructions for receiving the selected section of the program guide comprise instructions for receiving the selected section of the program guide in a unicast transmission over a data network.

76. The computer-readable media of claim 71, further comprising instructions for transmitting a request for the selected section of the program guide.

77. The computer-readable media of claim 71, wherein said instructions for receiving the guide state notification message comprise instructions for receiving a version identifier of the selected section of the program guide.

78. The computer-readable media of claim 77, wherein said instructions for determining comprise instructions for comparing the version identifier with a stored version identifier.

79. The computer-readable media of claim 71, wherein said instructions for receiving the guide state notification message comprise instructions for receiving a broadcast identifier that identifies when the selected section of the program guide is to be broadcast over a data network.

80. The computer-readable media of claim 71, wherein said instructions for receiving the guide state notification message comprise instructions for receiving the guide state notification message over a wireless data network.

81. Apparatus comprising at least one processor configured to implement a method comprising:
receiving a program guide state notification message that identifies a selected section of the program guide;
determining that a stored copy of the program guide needs to be updated;
receiving the selected section of the program guide; and
updating the stored copy of the program guide with the selected section of the program guide.

82. The apparatus of claim 81, wherein said receiving the guide state notification message comprises receiving a broadcast of the guide state notification message over a data network.

83. The apparatus of claim 81, wherein said receiving the guide state notification message comprises receiving the guide state notification message in a unicast transmission over a data network.

84. The apparatus of claim 81, wherein said receiving the selected section of the program guide comprises receiving a broadcast of the selected section of the program guide over a data network.

85. The apparatus of claim 81, wherein said receiving the selected section of the program guide comprises receiving the selected section of the program guide in a unicast transmission over a data network.

86. The apparatus of claim 81, further comprising transmitting a request for the selected section of the program guide.

87. The apparatus of claim 81, wherein said receiving the guide state notification message comprises receiving a version identifier of the selected section of the program guide.

88. The apparatus of claim 87, wherein said determining comprises comparing the version identifier with a stored version identifier.

89. The apparatus of claim 81, wherein said receiving the guide state notification message comprises receiving a broadcast identifier that identifies when the selected section of the program guide is to be broadcast over a data network.

90. The apparatus of claim 81, wherein said receiving the guide state notification message comprises receiving the guide state notification message over a wireless data network.
